(19) United States
(12) Patent Application Publication
(10) Pub. No.: US 2010/0064178 A1
(43) Pub. Date: Mar. 11, 2010

(54) World-Readiness and Globalization Testing Assemblies

(75) Inventors: Suneetha Dhulipalla, Sammamish, WA (US); Hugo G. Garcia, Seattle, WA (US); Blake Prescott Kuver, Sammamish, WA (US); Tatiana Racheva, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/208,128

(22) Filed: Sep. 10, 2008

(51) Int. Cl. G06F 11/36; G06F 11/00

(52) U.S. Cl. 714/38; 714/E11.207

(57) ABSTRACT

World-readiness and globalization testing assemblies may be provided. A software application may be analyzed to identify user interface controls. These controls may then be tested according to language or culture-specific test cases developed in advance by language experts. Testing may include sending predefined output to the application and intercepting the resulting output. The output may then be compared to an expected response to ensure that the actual output display matches the correct output display. The results of the test may be reported and errors may result in automatically opening a bug report.

### BACKGROUND

World-readiness and globalization testing assemblies provide a unified mechanism for testing language-specific features efficiently without having to speak or understand the tested language. In some situations, testing features for world-readiness has required individual testing by those with expertise in the tested language. For example, languages like Thai require sequence checking as characters are typed to verify that the input sequence entered on a keyboard results in a valid set of characters. Thus, the conventional strategy is to require someone to learn the valid and invalid character sequences before being able to write a test case. This often causes problems because the conventional strategy does not enable non-native language speakers to thoroughly test language-specific features.

### SUMMARY

World-ready and globalization assemblies may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

World-readiness and globalization testing assemblies may be provided. A software application may be analyzed to identify user interface controls. These controls may then be tested according to language or culture-specific test cases developed in advance by language experts. Testing may include sending predefined output to the application and intercepting the resulting output. The output may then be compared to an expected response to ensure that the actual output display matches the correct output display. The results of the test may be reported and errors may result in automatically opening a bug report.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment for providing world-readiness and globalization testing assemblies;

FIG. 2 is a diagram of a relationship between application features and test cases;

FIG. 3 is a screen shot illustrating an exemplary user interface for testing feature elements;

FIG. 4 is a flow chart of a method for providing world-readiness and globalization assemblies;

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

World-readiness and globalization testing assemblies may be provided. Consistent with embodiments of the present invention, a software application may be analyzed to identify user interface controls. These controls may then be tested according to language or culture-specific test cases developed in advance by language experts. Testing may include sending predefined output to the application and intercepting the resulting output. The output may then be compared to an expected response to ensure that the actual output display matches the correct output display. The results of the test may be reported and errors may result in automatically opening a bug report.

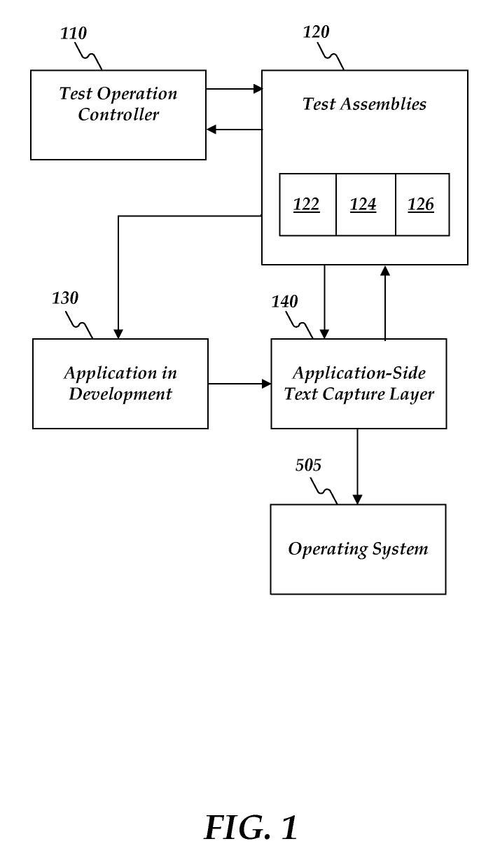

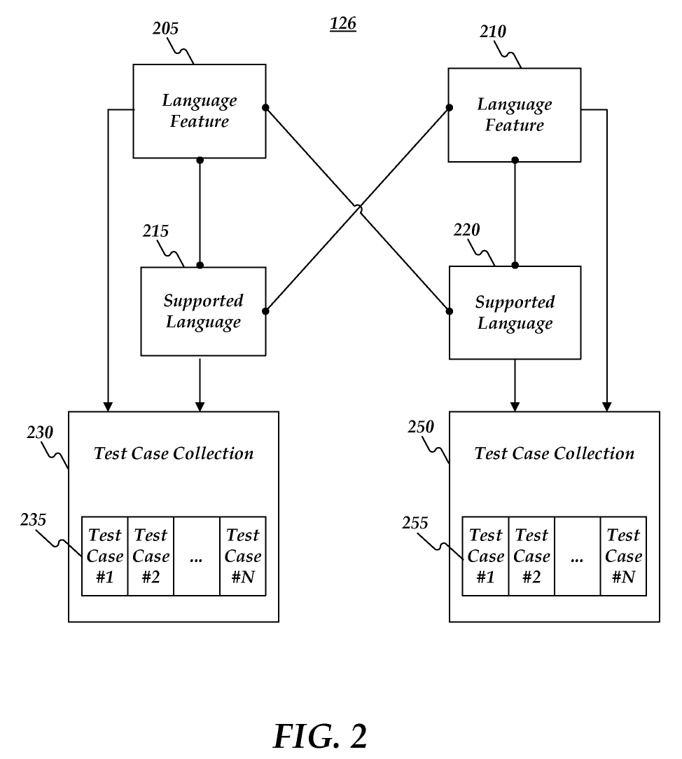

FIG. 1 is a system 100 of an operating environment for providing world-readiness and globalization testing assemblies. System 100 may include a test operation controller 110, a test assembly collection 120, an application 130, an application side text capture layer 140, and a display 150. Test assemblies 120 may include a text capture assembly 122, a globalization assembly 124, and a world-readiness assembly 126. For example, text capture assembly 122 may contain instructions for driving application side text capture layer 140 and verifying data received from application 130. World-readiness assembly 126 is described in greater detail below with respect to FIG. 2.

FIG. 2 is a diagram illustrating the relationship between application features and test cases within world-readiness assembly 126. World-readiness assembly 126 may include at least a first language feature 205, and may include additional language features such as a second language feature 210. For example, language features may include sort order, date format, time format, keyboard layout, character sequence checking, spell-checking, localization conversion, word-breaking, and character set.

Consistent with exemplary embodiments, an application in development 130 may have a plurality of feature elements. For example, application 130 may include elements such as a save functionality, a plurality of user interface controls, a plurality of inputs, and a plurality of outputs. Each element may support first language feature 205 and/or second language feature 210. Each element may also support a first supported language 215 and/or a second supported language 220. Consistent with embodiments of the invention, each element may support additional features and/or languages.

First language feature 205 and second language feature 210 may each be associated with first supported language 215 and second supported language 220. First language feature 205 and associated first supported language 215 may be associated with a test case collection 230. Test case collection 230 may comprise a plurality of test cases 235. Second language feature 210 and associated second supported language 220 may be associated with a second test case collection 250. Second test case collection 250 may comprise a plurality of test cases 255.

World-readiness assembly 126 may be implemented as a software object. For example, test case collection 230 may comprise an interface providing access to plurality of test case 235. Each test case may further comprise an individual test to be performed to validate the proper functioning of first language feature 205 and first supported language 215 associated with test case collection 230. The interface of test case collection 230 may provide a method for iterating through any or all of plurality of test cases 235. Test case collection may further comprise any or all of a plurality of properties comprising a count of the number of test cases, a culture associated with first language feature 205 and/or first supported language 215, a string name for test case collection 230, and a definition of which of plurality of test cases 235 should be accessed by the iteration method of test case collection 230.

Each test case in plurality of test cases 235 may comprise any or all of a string description of the individual test, an expected output result, instructions for preparing the element being tested which may include control instructions for an input device and an output device and/or instructions for clearing any current data in the element, a unique identifier for the individual test case which may be used to identify the results of the individual test, and a sample input.

Globalization assembly 124 may comprise a class collection for testing a feature element's international sufficiency without the need for a tester to have language or culture-specific knowledge. Globalization assembly 124 may thus comprise instructions for creating or modifying an operating environment, using appropriate test data for the feature element and language/culture combination being tested, and validating that the feature element performs correctly. For example, the operating environment may comprise an application's installation language, a current user culture, or an active keyboard layout.

Globalization assembly 124 may comprise at least one of language settings and keyboard settings. Consistent with exemplary embodiments, globalization assembly 124 may comprise either or both setting categories which may be used to create or ensure a proper environment for a test to run. For example, language settings may comprise an application's user-interface language, fallback language order, installation language, and primary editing language. Keyboard settings may, for example, comprise instructions for changing a current keyboard layout based on a culture, a layout identifier, or a particular input editor. Keyboard settings may further comprise an ability to change a keyboard layout only long enough for the duration of the test before reverting the keyboard layout to its original configuration.

Globalization assembly 124 may further comprise data for testing sorting, spelling, date, and string generation in a plurality of languages and/or cultures. For example, globalization assembly 124 may provide a sorting test data repository comprising an unsorted list of words in a particular language and a correct, sorted order. The sorted order may be provided in ascending and/or descending order. The unsorted list of words may be randomized each time the test is used for greater variation or a fixed random seed may be used to create deterministic results. The sorting test data may be further divided according to a particular culture within the language, such as Chinese-Bopomofo or Spanish-Traditional.

Spelling data may provide lists of correctly and incorrectly spelled words in different languages in order to test proofing tool integration. The spelling data may also be used to provide real words for a given language for use in other tests. The spelling data in globalization assembly 124 may comprise information regarding a language's capitalization rules and number rules.

Date data in globalization assembly 124 may comprise information related to testing date formats in a language and/or culture without having to know calendar or format variations. The date data may comprise a date format for a user's locale, language, and/or culture, a calendar type (e.g. Gregorian, Japanese Emperor, Thai Buddhist, etc.), and a language for date names (e.g. Spanish month names for a Gregorian calendar type). Date tests may apply date formats, convert dates between calendars, adjust dates (e.g. add one day to a deadline), sort dates, and compare dates.

String generation data in globalization assembly 124 may comprise information for generating random strings for other tests in a particular language or culture. The string generation data may accept constraints from a test administrator for a particular application. For example, the test administrator may set constraints such as a maximum length (e.g. 32 characters), a character type (e.g. numbers only), an excluded character list (e.g. exclude “@*\?”), and a specified format (e.g. “*@*.com” for an email address). String generation data may also generate dates and/or currencies.

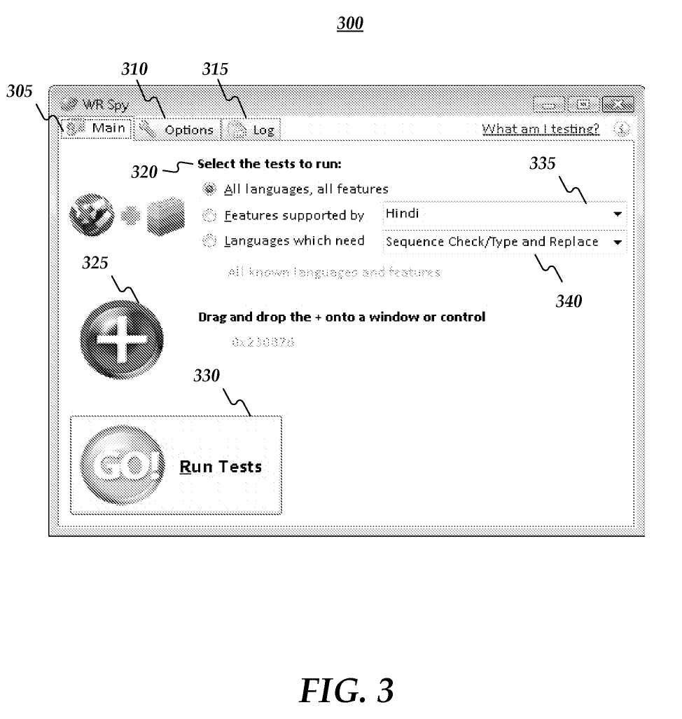

FIG. 3 is a screen shot illustrating an exemplary user interface 300 for testing feature elements. Interface 300 may comprise a main tab 305, an options tab 310, a log tab 315, a test selection menu 320, an element selector 325, a run test button 330, a supported language selector 335, and a supported feature selector 340. Interface 300 may be used by a test administrator without requiring knowledge of the languages and/or cultures being tested. Interface 300 may automatically find editable controls in an application and run test cases to determine and verify globalization validity and world-readiness. Interface 300 may use globalization assemblies, as discussed above, to install, create, and modify the operating environment of the application to run the test cases. For example, interface 300 may install a new keyboard layout, switch to the new keyboard layout, retrieve a test input from a test case, enter the test input with the new keyboard layout, and verify the results from the input. Interface 300 may then produce a log of the test case and outcome (e.g. pass/fail) which may be viewed in log tab 315.

Interface 300 may be used to test a specific application element and/or a limited subset of languages and/or features. Element selector 325 may be used to select a particular element within the application to be tested. For example, element selector 325 may be dragged to a “To:” input field in an email application's new message window. Consistent with exemplary embodiments, element selector 325 may be dragged and dropped anywhere on the application to be tested. Interface 300 may then identify and enumerate all elements in the application and determine if the element has a supported test case. Interface 300 may then add such elements to a test queue. During execution of the test cases for each element in the test queue, interface 300 may display information about the current test case and overall progress. For each test case, interface 300 may determine if the test passed or failed. If a test fails, interface 300 may optionally retry the test, stop any further testing, or move on to the next test case. Interface 300 may request input from a user before following one of these options or a default option may be set in option tab 310.

Supported language selector 335 may be used to only execute test cases that apply to a particular language (e.g. Hindi). Supported feature selector 340 may be used to only execute test cases that apply to a particular language feature (e.g. word breaking or sequence checking). Interface 300 may also run tests for all supported languages on all supported features.

Interface 300 may install additional features, such as keyboard layouts, in order to run the test cases. These installations may be tracked for removal after the tests are completed.

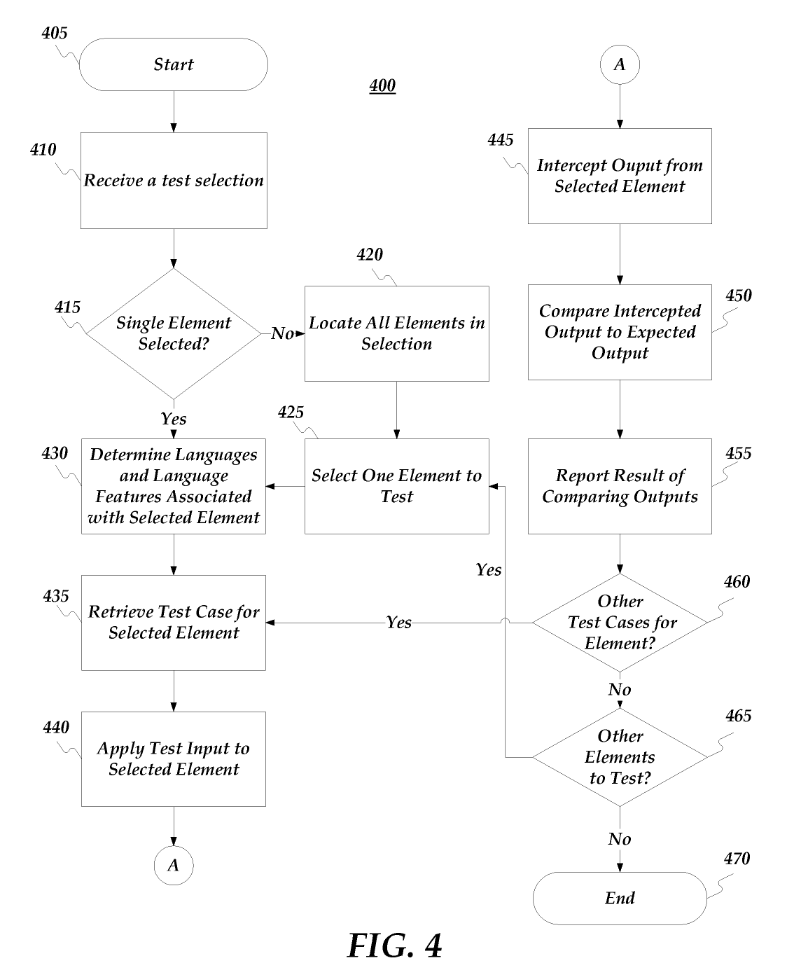

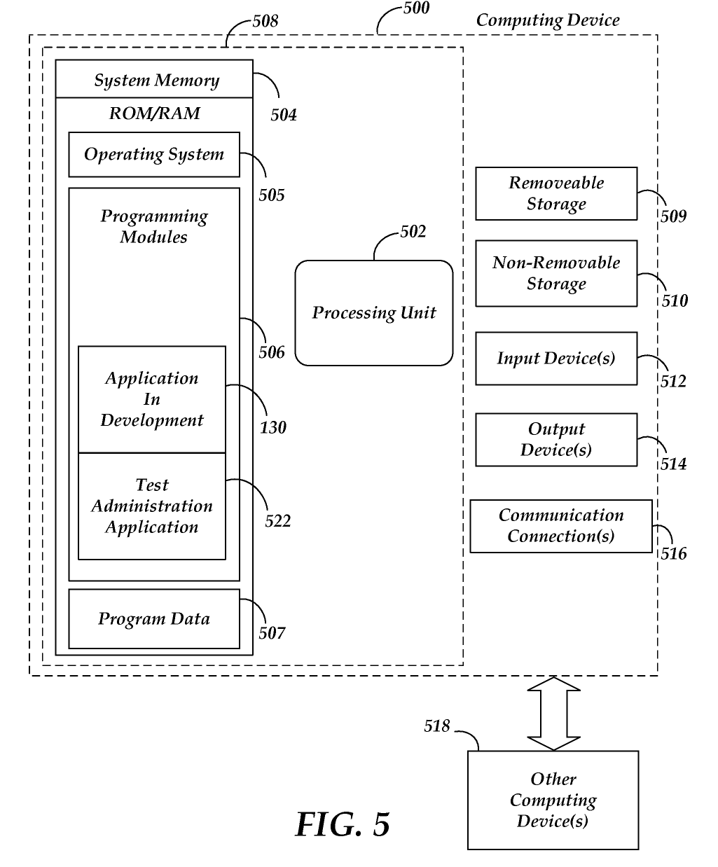

FIG. 4 is a flow chart setting forth the general stages involved in a method 400 consistent with an embodiment for providing world-readiness and globalization assemblies. Method 400 may be implemented using a computing device 500 as described in more detail below with respect to FIG. 5. Ways to implement the stages of method 400 will be described in greater detail below. Method 400 may begin at starting block 405 and proceed to stage 410 where computing device 500 may receive a test selection. For example, a test administrator may select application in development 130. Consistent with embodiments of the invention, the test administrator may also select an single element and/or a subset of elements of application in development 130. The test selection may be received by interface 300, as described above with respect to FIG. 3. Interface 300 may be provided by a test administration application 522.

From stage 410, method 400 may advance to stage 415 where computing device 500 may determine whether more than one element has been selected for testing. For example, interface 300 may receive application in development 130 as a test selection. Method 400 may then advance to stage 420, where computing device 500 may cause interface 300 may to locate some and/or all potential elements from application in development 130 for testing. In response to locating multiple elements for testing, method 400 may advance to 425, where computing device 500 may select one of the multiple elements to test. For example, the test administrator may manually select one of the available elements to be tested. Consistent with embodiments of the invention, computing device 500 may loop through each of the multiple elements in turn.

Method 400 may then advance to stage 430 where computing device 500 may determine locales, cultures, languages, and/or language features associated with the selected element. For example, computing device 500 may determine that the selected element supports text inputs from a variety of languages and/or that the selected element supports at least one language-dependent characteristic. Consistent with embodiments of the invention, a world-readiness assembly may collect a number of individual test cases associated with each language/characteristic pairing. Language-dependent characteristics may include sort order, date format, time format, keyboard layout, character sequence checking, localization conversion, word-breaking, and character set (e.g. font).

Method 400 may then advance to stage 435 where computing device 500 may retrieve at least one test case associated with testing at least one language. The at least one test case may comprise at least one sample input and at least one expected output. Consistent with embodiments of the invention, each test case may be developed independently of application in development 130 by an expert in the at least one language associated with the test case. This enables the test administrator to make use of each test case in a plurality of applications without needing expertise in the language being tested.

Method 400 may then advance to stage 440 where computing device 500 may apply the sample input from the test case to the selected element. For example, computing device 500 may send a string to a text input field in application in development 130 and verify that the string is correctly received by the element. Consistent with exemplary embodiments of the invention, the string to be sent may be provided by the test case. The string to be sent may also be provided by the string generation functionality of globalization assembly 124.

Method 400 may then advance to stage 445 where computing device 500 may intercept the data received by application in development 130 and compare the received data to the sample input to ensure that the data is correctly received.

Method 400 may then advance to stage 450 where computing device 500 may compare output from application in development 130 produced in response to the sample input to an expected output associated with the test case. Input and output interception may be provided by text capture assembly 122. Text capture assembly 122 may load application side text capture layer 140 that may intercept all data passing between application in development 130 and an operating system 505. Text capture assembly 122 may load a test side text capture layer that may similarly intercept all data passing between test administration application 522 and application in development 130. Consistent with embodiments of the invention, text capture assembly 122 may substitute function pointers for the text input/output programming interfaces of application in development 130 with pointers to functions within application side text capture layer 140. The test side text capture layer may instruct application in development 130 to redraw its output display, which may result in application in development 130 calling the function pointers in application side text capture layer 140. The output display may then be passed on to operating system 505 and displayed normally on output device 514.

Application side text capture layer 140 function pointers may each accept parameters that may be saved in an array of XML structures. The array of XML structures may be written to shared memory for later processing and verification. The array of XML structures may also be passed to world-readiness assembly 126 to verify that the sample input was correctly received. The output from application in development 130 may be intercepted and compared to the expected output in the test case. The intercepted output may be compared to the expected output based on a text comparison and/or a visual appearance comparison. For example, a character sequence in a language may comprise the same underlying character codes, but have a different visual representation based on different language, locale, or culture settings. The test case may then compare the visual representation of the intercepted output to an expected visual representation for the test case.

Method 400 may then advance to stage 455 where computing device 500 may report a result of the comparison between the intercepted output and the expected output. For example, text capture assembly 122 may send the result to test administration application 522, where the results may be viewed in log tab 315. Consistent with exemplary embodiments of the invention, results may also be reported by world-readiness assembly 126.

Method 400 may then advance to stage 460 where computing device 500 may determine whether another test case is associated with the element and/or language feature to be tested. For example, test case #1 in test case collection 230 associated with language feature 205 and supported language 215 may be performed and the results reported before method 400 causes computing device 500 to return to stage 435 and perform test case #2 in test case collection 230. Consistent with exemplary embodiments, computing device 500 may also select test case collection 250 associated with language feature 205 and supported language 220 and return to stage 435.

Method 400 may then advance to stage 465 where computing device 500 may determine whether another element, language feature 210, for example, is selected for testing. For example, method 400 may complete testing of language feature 205 and return to stage 425, where language feature 210 is selected for testing.

After each of the selected elements has been tested, method 400 may end at stage 470.

An embodiment consistent with the invention may comprise a system for providing globalization and world-readiness assemblies. The system may comprise a memory storage and a processing unit coupled to the memory storage. The processing unit may be operative to determine supported features and/or languages in application in development 130 and verify that the supported features correctly accept sample inputs and produce outputs according to at least one test case for at least one supported language. Consistent with exemplary embodiments, the supported feature may comprise an input field, an output field, and a user interface control.

Another embodiment consistent with the invention may comprise a system for providing world-readiness testing. The system may comprise a memory storage and a processing unit coupled to the memory storage. The processing unit may be operative to identify features such as user interface controls, inputs, and outputs in an application, receive a selection of at least one of the features and at least one language and/or culture to test, and verify that the at least one feature functions correctly for the at least one language and/or culture. For example, interface 300 may locate all features within application in development 130 and present a list of the features to a user for selection. Consistent with exemplary embodiments, interface 300 may locate and list a subset of the features within application in development 130. For example, interface 300 may locate, identify, and list only those features for which a test case is available to interface 300.

FIG. 5 is a block diagram of a system including computing device 500. Consistent with an embodiment of the invention, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the invention. Furthermore, computing device 500 may comprise an operating environment for system 100 as described above. System 100 may operate in other environments and is not limited to computing device 500.

With reference to FIG. 5, a system consistent with an embodiment of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include application in development 130 and/or test administration application 522. Program data 507 may include storage of test data, such as test case collection 230 and test case collection 250. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g. test administration application 130) may perform processes including, for example, one or more of method 400's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

1. A method for providing globalization and world-readiness testing assemblies, the method comprising:
determining at least one language supported by at least one element of an application;
determining whether the at least one element receives an input and displays an output; and
in response to determining that the at least one element accepts the input and displays the output, verifying that the input is correctly accepted by the at least one feature and that the output is correctly displayed by the at least one feature for the at least one language supported by the at least one feature.

2. The method of claim 1, further comprising:
determining at least one language feature associated with the at least one element; and
verifying that the at least one language feature associated with the at least one element is correctly implemented for the at least one language.

3. The method of claim 2, wherein the at least one language feature comprises at least one of: sort order, date format, time format, keyboard layout, character sequence checking, spell-checking, localization conversion, word-breaking, and character set.

4. The method of claim 2, wherein verifying that the input is correctly accepted by the at least one feature and that the output is correctly displayed by the at least one feature for the at least one language supported by the at least one feature further comprises performing a plurality of test cases associated with at least one test case collection associated with the at least one language and the at least one language feature.

5. The method of claim 1, wherein verifying that the input is correctly accepted for the at least one language supported by the at least one feature comprises:
retrieving at least one test case associated with the at least one language;
reading at least one sample input from the at least one test case;
sending the at least one sample input from the at least one test case to the input; and
verifying that the at least one sample input is correctly received by the at least one feature.

6. The method of claim 5, wherein retrieving at least one test case associated with the at least one language comprises retrieving the at least one test case from a central repository comprising at least one test case collection.

7. The method of claim 6, wherein the central repository comprises a plurality of test case collections associated with a plurality of languages and a plurality of language features.

8. The method of claim 5, wherein verifying that the at least one sample input is correctly received by the at least one element comprises comparing the input received by the at least feature to the at least one sample input.

9. The method of claim 1, wherein verifying that the output is correctly displayed for the at least one language supported by the at least one element comprises:
retrieving at least one test case associated with the at least one language;
reading at least one sample input from the at least one test case;
sending the at least one sample input from the at least one test case to the input; and
intercepting the output as rendered by the application according to the at least one sample input.

10. The method of claim 1, wherein verifying that the output is correctly displayed by the at least one feature further comprises:
retrieving a sample output from the at least one test case; and
comparing the rendered output to the sample output.

11. A computer-readable medium which stores a set of instructions which when executed performs a method for providing world-readiness testing, the method executed by the set of instructions comprising:
identifying at least one user interface control in an application;
receiving a selection of at least one language for which to test the at least one user interface control; and
verifying that the at least one user interface control functions correctly for the at least one language, wherein verifying that the at least one user interface control functions correctly for the at least one language comprises:
receiving, from at least one test case associated with the at least one language, at least one input to apply to the at least one user interface control;
applying the at least one input to the at least one user interface control in the application; and
determining whether the at least one user interface control produces the correct response in the application in response to applying the at least one input to the at least one user interface control in the application.

12. The computer-readable medium of claim 11, wherein identifying the at least one user interface control in an application comprises receiving a selection of at least one of a plurality of user interface controls in the application.

13. The computer-readable medium of claim 12, wherein prior to receiving a selection of the at least one of a plurality of user interface controls in the application, the set of instructions further comprises:
locating all of the user interface controls in the application; and
presenting a list of all of the user interface controls in the application to a user.

14. The computer-readable medium of claim 11, wherein the at least one test case comprises at least one of a plurality of application-independent test cases for each of a plurality of languages.

15. The computer-readable medium of claim 11, wherein the set of instructions further comprises:
in response to determining whether the at least one user interface control produces the correct response in the application in response to applying the at least one input to the at least one user interface control in the application, reporting the results to at least one user.

16. The computer-readable medium of claim 15, wherein the set of instructions further comprises:
in response to determining that the at least one user interface control does not produce the correct response in the application in response to applying the at least one input to the at least one user interface control in the application, adding a bug report to a task list.

17. The computer-readable medium of claim 11, wherein the set of instructions further comprises:
determining whether at least one second test case associated with the at least one language is available; and
in response to determining that the at least one second test case associated with the at least one language is available, verifying that the at least one user interface control functions correctly for the at least one language according to the at least one second test case.

18. The computer-readable medium of claim 11, wherein determining whether the at least one user interface control produces the correct response in the application in response to applying the at least one input to the at least one user interface control in the application comprises:
receiving the output produced by the application; and
determining whether a visual representation of the output produced by the application matches a correct visual representation of the output associated with the at least one test case.

19. A system for providing world-readiness and globalization testing, the system comprising:
a memory storage; and
a processing unit coupled to the memory storage, wherein the processing unit is operative to:
receive a selection of an application;
locate a plurality of user interface controls in the application;
display a list of the plurality of user interface controls in the application to a user;
receive a selection of at least one user interface control from the plurality user interface controls in the application;
receive a selection of at least one language for which to test the at least one user interface control;
retrieve at least one test case associated with the language for which to test the at least one user interface control, wherein the test case comprises data associated with testing at least one language-dependent characteristic of the at least one user interface control;
apply at least one input associated with the test case to the at least one user interface control in the application;
determine whether the at least one user interface control produces the correct response in the application in response to applying the at least one input to the at least one user interface control in the application, wherein being operative to determine whether the at least one user interface control produces the correct response in the application in response to applying the at least one input to the at least one user interface control in the application comprises being operative to:
intercept a display output of the application in response to the applied at least one input, and
compare the visual rendering of the intercepted output to an expected output associated with the at least one test case; and
report the results of determining whether the at least one user interface control produced the correct response in the application in response to applying the at least one input to the at least one user interface control in the application to the user.

20. The system of claim 19, wherein the at least one language-dependent characteristic comprises at least one of: sort order, date format, time format, keyboard layout, character sequence checking, localization conversion, word-breaking, and character set.
